(19) United States
(12) Patent Application Publication
(10) Pub. No.: US 2026/0196071 A1
(43) Pub. Date: Jul. 9, 2026

(54) TABLE RECOGNITION METHOD FOR DOCUMENT AND RELATED APPARATUS

(71) Applicant: INSTITUTE OF MEDICAL INFORMATION, CHINESE ACADEMY OF MEDICAL SCIENCES, Beijing (CN)

(72) Inventors: Xiaoli TANG, Beijing (CN); Xiaoying LI, Beijing (CN); Yongjie LI, Beijing (CN); Yinan SUN, Beijing (CN); Peixuan MEN, Beijing (CN)

(73) Assignee: INSTITUTE OF MEDICAL INFORMATION, CHINESE ACADEMY OF MEDICAL SCIENCES, Beijing (CN)

(21) Appl. No.: 19/413,020

(22) Filed: Dec. 9, 2025

(30) Foreign Application Priority Data
Jan. 6, 2025 (CN) 202510016587.3

(51) Int. Cl. G06V 30/413; G06V 10/26; G06V 10/44; G06V 10/72; G06V 10/774; G06V 10/82

(52) U.S. Cl. CPC G06V 30/413; G06V 10/26; G06V 10/44; G06V 10/72; G06V 10/774; G06V 10/82

(57) ABSTRACT

A table recognition method for a document file and a related apparatus. The method includes: converting a page of a to-be-processed document file into a first image; performing image enhancement on the first image to obtain a second image; performing table detection on the second image using a target agent to obtain table-area position information of a table in the second image, where the target agent is a table detection model constructed based on deep learning-based dual-branch model optimization, a first branch of the target agent being configured to learn and extract structural features of the table, and a second branch of the target agent being configured to learn and extract text semantic features of the table; and recognizing table data in a table area indicated by the table-area position information and converting recognized table data into data in a structured format for outputting.

### CROSS-REFERENCE TO RELATED APPLICATION

This application claims priority to Chinese Patent Application No. 202510016587.3, filed on Jan. 6, 2025, which is hereby incorporated by reference in its entirety.

### FIELD

The present disclosure relates to the technical field of computer application and artificial intelligence, and in particular to a table recognition method for a document file and a related apparatus.

### BACKGROUND

In the known technology, although there was a certain development of structured processing technologies in table recognition for document files and a certain achievement has been obtained in simple scenarios, the following problems still remain when processing a complex document file: 1) low accuracy of table recognition, especially for tilted, curved, or noise-contained tables; 2) slow speed of table recognition, making it difficult to meet requirements for processing large-scale data; 3) poor adaptability to table styles, making it difficult to handle the diversified layouts of tables.

Therefore, existing table recognition processing technologies still need to be improved in accuracy, speed, adaptability and the like for the complex document files. How to improve the table recognition processing technologies in one or more aspects of recognition accuracy, recognition speed, recognition adaptability and the like becomes a problem worthy of attention in this field.

### SUMMARY

In view of this, a table recognition method for a document file and a related apparatus are provided according to the present disclosure, to perform table recognition with high accuracy, high efficiency and high adaptability on the document file by combining technologies such as image enhancement and deep learning model tuning.

The specific technical solutions are as follows.

A table recognition method for a document file is provided. The method includes: converting a page of a to-be-processed document file into a first image; performing image enhancement on the first image to obtain a second image, where the image enhancement is performed to at least implement angle correction of the first image; performing table detection on the second image using a target agent to obtain table-area position information of a table in the second image, where the target agent is a table detection model constructed based on deep learning-based dual-branch model optimization, a first branch of the target agent being configured to learn and extract structural features of the table, and a second branch of the target agent being configured to learn and extract text semantic features of the table; and recognizing table data in a table area indicated by the table-area position information and converting recognized table data into data in a structured format for outputting.

In an embodiment, the performing image enhancement on the first image includes: performing at least one of size standardization, grayscale conversion, binarization, table contour detection, angle correction, as well as denoising and sharpening processing on the first image.

In an embodiment, the size standardization is performed by: determining an adaptive factor for controlling an adjustment degree of an interpolation kernel based on geometric features of the table in the first image; and adjusting a size and shape of the interpolation kernel based on the adaptive factor, and performing interpolation-based scaling on the first image using an adjusted interpolation kernel to obtain a standard-sized image.

In an embodiment, the grayscale conversion is performed by: performing color-space analysis on the first image or an image obtained through performing the size standardization on the first image to obtain a color-space analysis result; assigning a weight to each color based on a distribution and importance of this color, characterized by the color-space analysis result, in the first image or the image obtained through performing the size standardization on the first image; based on the weight corresponding to each color in color channels of each pixel in the first image or the image obtained through performing the size standardization on the first image, performing weighted averaging on brightnesses of colors involved in the color channels of the pixel, to obtain a weighted average result of the brightnesses of the pixel; and converting the first image or the image obtained through performing the size standardization on the first image into a grayscale image based on the weighted average result of the brightnesses of each pixel.

The binarization is performed by: dividing the grayscale image into multiple local windows; calculating a local contrast of pixels within each of the local windows; for each of the local windows, determining a binarization threshold for each pixel based on the local contrast of the pixels and a preset contrast threshold; and converting the grayscale image into a binary image based on the binarization threshold corresponding to each pixel.

In an embodiment, the table contour detection is performed by: extracting a low-level feature and a high-level feature of the binary image using a convolutional neural network, where the low-level feature comprises a basic image feature of the binary image, the high-level feature comprises table structure information in the binary image, and the binary image is a result of binarizing the first image; performing feature fusion on extracted low-level feature and high-level feature using an attention mechanism to obtain a feature fusion result, where the feature fusion is performed to highlight features related to a contour of the table; and generating a contour information graph of the table in the binary image based on the feature fusion result.

The angle correction is performed by: determining text rows and table rows in the binary image based on the contour information graph; determining a tilt angle of the binary image based on a tilt-angle voting result of each of the text rows and table rows in the binary image through a regional voting mechanism; and performing angle correction on the binary image based on the tilt angle of the binary image.

In an embodiment, the denoising and sharpening processing is performed by: determining a denoising parameter based on a noise level of an input image, and determining a sharpening parameter based on local features of the input image; where the input image is an image obtained through processing of the first image; and denoising the input image based on the denoising parameter and sharpening the input image based on the sharpening parameter.

In an embodiment, a process for constructing the target agent includes at least a one of the following: providing, through transfer learning, pre-trained model weights respectively for a first deep learning model in the first branch and a second deep learning model in the second branch, where a pre-trained model weight provided for the first deep learning model is used to extract structural features of the table, and a pre-trained model weight provided for the second deep learning model is used to extract text semantic features of the table; optimizing an obtained first deep learning model and an obtained second deep learning model obtained through the transfer learning using small sample learning; and performing data augmentation on samples in the small sample learning, and optimizing the obtained first deep learning model and the obtained second deep learning model obtained through the transfer learning using the augmented samples, where during the optimizing, the first deep learning model and the second deep learning model are optimized independently in respective branches, and share table information and features.

A table recognition apparatus for a document file is provided. The apparatus includes an image conversion module, an image enhancement module, a table detection module and a table recognition module. The image conversion module is configured to convert a page of a to-be-processed document file into a first image. The image enhancement module is configured to perform image enhancement on the first image to obtain a second image, where the image enhancement is performed to at least implement angle correction of the first image. The table detection module is configured to table detection on the second image using a target agent to obtain table-area position information of a table in the second image, where the target agent is a table detection model constructed based on deep learning-based dual-branch model optimization, a first branch of the target agent being configured to learn and extract structural features of the table, and a second branch of the target agent being configured to learn and extract text semantic features of the table. The table recognition module is configured to recognize table data in a table area indicated by the table-area position information and converting recognized table data into data in a structured format for outputting.

An electronic device is provided. The electronic device includes a memory and a processor. The memory is configured to store a computer program. The processor is configured to perform the table recognition method for a document file according to any one of the above described items by invoking and executing the computer program in the memory.

A computer readable medium storing a computer program is provided. The computer program performs, when being executed by a processor, the table recognition method for a document file according to any one of the above described items.

It can be seen from the above solution that, in the table recognition method for a document file and the related apparatus provided according to the present disclosure, a target agent for table detection is pre-constructed based on deep learning-based dual-branch model optimization. The target agent includes a first branch which is configured to learn and extract structural features of the table and a second branch which is configured to learn and extract text semantic features of the table. On this basis, for a document file to be subjected to table recognition, table recognition is performed on the document file through a combination of technologies such as image enhancement and deep learning model optimization by: converting the document file to be subjected to table recognition into a first image, performing image enhancement on the first image to obtain a second image, and performing table detection on the second image using the target agent, and then performing table data recognition based on detected table-area position information. In the present disclosure, table recognition with high accuracy, high efficiency, and high adaptability may be performed on a document file by combining technologies such as image enhancement and deep learning-based dual-branch model optimization in table recognition.

### BRIEF DESCRIPTION OF THE DRAWINGS

In order to describe the technical solutions in the embodiments of the present disclosure or in the conventional technology more clearly, the drawings for describing the embodiments or the conventional technology are briefly introduced hereinafter. Apparently, the drawings in the following description show merely the embodiments of the present disclosure, and those skilled in the art can obtain other drawings based on these drawings without creative efforts.

FIG. 1 is a flowchart of a table recognition method for a document file provided according to the present disclosure;

FIG. 2 is a modular design example diagram of a table recognition process provided according to the present disclosure;

FIG. 3 is a structural diagram of a table recognition apparatus for a document file provided according to the present disclosure; and

FIG. 4 is a structural diagram of an electronic device provided according to the present disclosure.

### DETAILED DESCRIPTION

The solutions in the embodiments of the present disclosure will be described clearly and completely hereinafter in conjunction with the accompanying drawings in the embodiments of the present disclosure. It is apparent that the described embodiments are only a part of the embodiments of the present disclosure rather than all of the embodiments. Based on the embodiments of the present disclosure, all other embodiments obtained by those skilled in the art without creative efforts fall into the protection scope of the present disclosure.

In embodiments of the present disclosure, a table recognition method for a document file and the related apparatus are provided. The method and related apparatus are applicable to, but not limited to recognize table data in a file in a portable document format and of a literature document type.

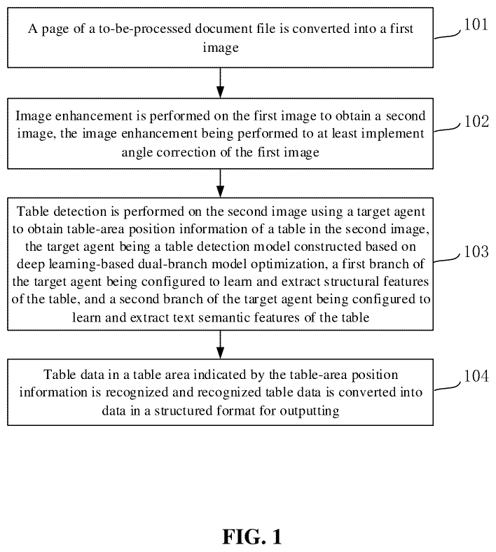

Referring to the schematic method flowchart shown in FIG. 1, a table recognition method for a document file provided according to embodiments of the present disclosure may include at least the following steps 101 to 104, which are described in detail below.

In step 101, a page of a to-be-processed document file is converted into a first image.

The to-be-processed document file may be, but not limited to, a portable document file in formats such as PDF, DOC, or DOCX.

For the to-be-processed document file in the formats such as PDF, DOC, or DOCX, in an embodiment, it may be loaded, and then may be parsed after being loaded. Each page of the document file may be converted into an image based on a parsing result, to obtain an image file of this page of the document file, which are referred to as a first image in the embodiments of the present disclosure.

For example, a document file is in PDF format. The document file may be, but not limited to, parsed by the MuPDF interface of Python to implement the parsing by a library. MuPDF is a lightweight PDF parsing library that supports multiple platforms and is customized for high-quality anti-aliased graphics, and through which a text is presented accurately with metrics and spacing within a fraction of a pixel.

In addition, in practice, a page of the to-be-processed document file may also be converted into an image by methods such as taking a screenshot, snapshooting, scanning, and photographing, to obtain the first image. Compared to image conversion methods such as taking a screenshot and snapshooting, the above image conversion method based on document parsing may better ensure image quality and conversion performance.

In step 102, image enhancement is performed on the first image to obtain a second image, the image enhancement being performed to at least implement angle correction of the first image.

The image enhancement performed on the first image may include, but is not limited to, some or all of size standardization, grayscale conversion, binarization, table contour detection, angle correction, as well as denoising and sharpening. In this step, high-quality image data is provided for subsequent table recognition steps by performing the image enhancement on the first image.

The various image enhancements performed on the first image include size standardization, grayscale conversion, binarization, table contour detection, angle correction, as well as denoising and sharpening.

In the size standardization, sizes of the images is adjusted to ensure that all input images have a uniform resolution, which contributes to the consistency and stability of the subsequent processing steps.

The grayscale conversion is used for converting a color image (such as the first image or the first image obtained through size standardization) into a grayscale image to simplify image data and reduce a calculation amount while retaining key information in a table structure in the image.

The binarization is used for converting a grayscale image into a binary image with only black and white, which contributes to highlight text and table lines in the image, thereby providing a basis for table contour detection and text recognition.

The table contour detection is used for detecting a contour of the table in the image (such as, the binary image) using image processing techniques, thereby providing a basis for subsequent angle correction of an image.

The angle correction is used for automatically adjusting a tilt angle of the image (such as the binary image) based on a detected contour of the table to eliminate tilting, table bending and the like due to image conversion such as scanning or photographing, thereby ensuring the accuracy of table recognition.

The denoising and sharpening are used for reducing random noise in an image (such as an image obtained through the angle correction) by denoising, and enhancing edge information of an image (such as the image obtained through the angle correction) by sharpening, thereby improving the accuracy of subsequent table recognitions.

In step 103, table detection is performed on the second image using a target agent to obtain table-area position information of a table in the second image, the target agent being a table detection model constructed based on deep learning-based dual-branch model optimization, a first branch of the target agent being configured to learn and extract structural features of the table, and a second branch of the target agent being configured to learn and extract text semantic features of the table.

In order to achieve high-accuracy and high-efficiency table recognition in complex scenarios, a table detection model, that is, the target agent, is constructed based on a dual-branch model optimization method in the embodiments of the present disclosure for table detection.

Further, in the embodiments of the present disclosure, the target agent is constructed based on an innovative dual-branch model optimization method by combining transfer learning, small-sample training and data augmentation, so that a model of the target agent may, for a table recognition task, be efficiently trained based on a small amount of labeled data, thereby significantly improving the recognition capability and adaptability of the model. The core idea of the dual-branch model optimization method of the embodiments of the present disclosure is to simultaneously optimize the generalization ability of the model on different table layouts and styles through parallel processing of a dual-branch structure, thereby enhancing its adaptability to a new task and new data.

The core concept of the dual-branch structure is to divide the processing process of the model into two parallel branches, each of which is optimized for different data processing tasks to better cope with the complexity of the table data and small-sample learning.

A first branch of the dual-branch structure is a branch for learning and extracting the structural features of the table, and the first branch is configured with a first deep learning model for learning and extracting the structural features of the table based on deep learning. The structural features of the table include, but are not limited to, table lines, cell relationships, and geometric properties of the table.

A second branch is a branch for learning and extracting semantic features, and the second branch is configured with a second deep learning model for learning and extracting text semantic features of the table based on deep learning. The text semantic features of the table include, but are not limited to, text content, data values, and table-header information.

The first deep learning model may be, but not limited to, deep learning models such as TabNet, and the second deep learning model may be, but not limited to, structured learning models such as StructEqTable.

The TabNet and StructEqTable models are described below.

### 1. Tabnet

TabNet is a deep learning model based on an attention mechanism, and aims to improve interpretability and performance of the model through a feature selection mechanism, which is mainly achieved through feature selection, the attention mechanism and multi-scale feature learning.

In terms of feature selection, TabNet uses a feature selection mechanism to determine which features to use in each layer, so that the model focuses on the most important information.

In terms of the attention mechanism, the model uses the attention mechanism to assign different weights to respective features, so that more complex feature relationships may be learned.

In terms of the multi-scale feature learning, TabNet processes features through multiple decision-making steps and scales to enable the model to capture different levels of feature information. Based on the above feature selection and attention mechanism, TabNet may achieve high-accurate table recognition in table recognition tasks; and the model may provide an explanation of the importances of the features, which contributes to understand how the model makes decisions. In addition, it is found that TabNet may also show good generalization ability when dealing with first encountered table structures.

### 2. Structeqtable

StructEqTable is a deep learning model for structured data (such as, tables) and improves prediction performance by learning structural information of the data, which is mainly achieved through structured representation, equilateral mapping and hierarchical learning.

In terms of the structured representation, the model converts table data into a structured representation that may be used to capture relationships between cells.

In terms of the equilateral mapping, StructEqTable uses the equilateral mapping to ensure that the model is unchanged for a changed arrangement of data in the table, that is, the model may recognize tables with different arrangements but the same content.

In terms of the hierarchical learning, the model learns the table data by a hierarchical way, and builds an understanding of the table from local features to a global structure.

StructEqTable may effectively recognize the structure of the table, and has strong robustness to changes in the arrangement and format of the data in the table. By learning the structural information of the data, the model may be trained based on less data to reduce the risk of overfitting. In addition, the model may adapt to different types of table structures, including complex and irregular table layouts.

The detailed construction process of a target agent based on the dual-branch model optimization will be described in detail in subsequent embodiments.

After obtaining a second image by performing image enhancement on the first image, the second image may be inputted to the target agent to extract structural features and text semantic feature of the table based on the dual-branch structure provided by the target agent, and then achieve accurate table detection based on a extracted structural features and text semantic features of the table to obtain the table-area position information of the table in the second image.

In step 104, table data in a table area indicated by the table-area position information is recognized and recognized table data is converted into data in a structured format for outputting.

After obtaining the table-area position information of the table in the second image, the table data in the table area indicated by the table-area position information may be further recognized.

In an embodiment, table data may be obtained by performing OCR (Optical Character Recognition) on a table area in a page image, that is, the second image. PaddleOCR may be preferably used for OCR of a table-area image to achieve high-accuracy and high-efficiency recognition of the table data.

PaddleOCR is an open source OCR tool based on deep learning and has the characteristics of fast recognition speed and high accuracy. PaddleOCR supports the recognition of multiple languages, so that the present disclosure may cope with the table recognition tasks of portable document format files in different languages. PaddleOCR may achieve an end-to-end text recognition for obtaining outputted text from an inputted image directly, thereby simplifying the processing process and improving recognition efficiency.

As can be seen from the above description, automated end-to-end table recognition with high efficiency and accuracy may be achieved through the method provided according to the embodiments of the present disclosure, so that a structured output result of the table data may be obtained directly based on the inputted page of a portable document format file. In an embodiment, the table data may be outputted in a structured format JSON. In embodiments of the present disclosure, manual intervention is reduced and processing efficiency is improved through the automated end-to-end table recognition process.

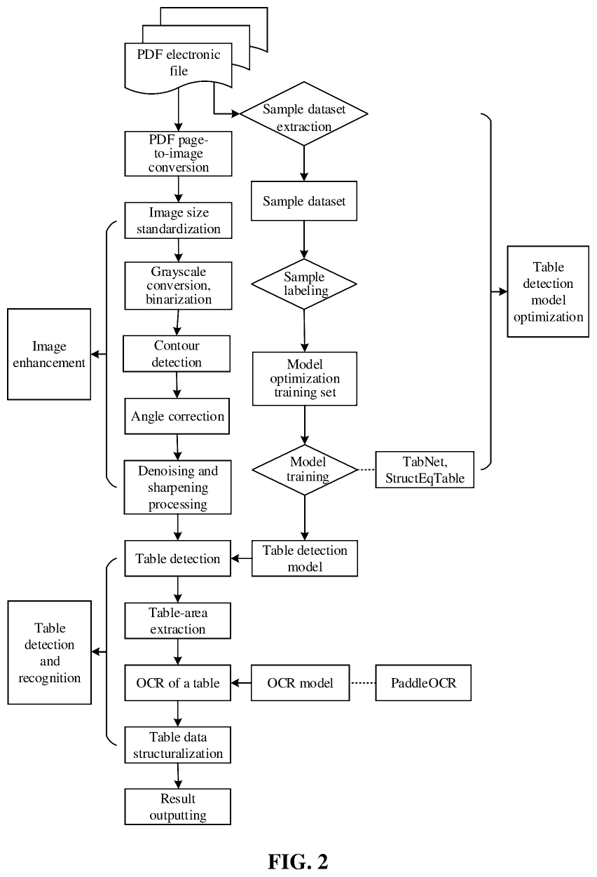

In practice, various processing steps (such as, image enhancement, dual-branch model optimization, table detection, and OCR) in the methods provided according to the present disclosure may be implemented through a modular design way. Referring to FIG. 2, a modular design example of various processing steps in the methods according to the present disclosure is provided. Modules include an image enhancement module, a table detection model optimization module, and a table detection and recognition module. Functions of modules are shown in FIG. 2. By using a modular design, system maintenance and upgrading may be facilitated.

It can be seen from the above solution that, in the table recognition method for a document file provided according to the present disclosure, a target agent for table detection is pre-constructed based on deep learning-based dual-branch model optimization. The target agent includes a first branch which is configured to learn and extract structural features of the table and a second branch which is configured to learn and extract text semantic features of the table. On this basis, for a document file to be subjected to table recognition, table recognition is performed on the document file through a combination of technologies such as image enhancement and deep learning model optimization by: converting the document file to be subjected to table recognition into a first image, performing image enhancement on the first image to obtain a second image, and performing table detection on the second image using the target agent, and then performing table data recognition based on detected table-area position information. In the present disclosure, table recognition with high accuracy, high efficiency, and high adaptability may be performed on a document file by combining technologies such as image enhancement and deep learning-based dual-branch model optimization in table recognition.

In particular, in embodiments of the present disclosure, high-quality image data is provided for subsequent table recognitions by performing the image enhancements such as size standardization, grayscale conversion, binarization, contour detection, angle correction, as well as denoising and sharpening processing on a page image of a document file. A recognition ability of the model (the target agent) in complex scenarios is improved by using an advanced table detection model with dual-branch structures such as TabNet, StructEqTable and by small-sample optimization. A text recognition with a high-accuracy and high-efficiency is achieved by performing OCR on a table-area image using OCR technologies such as PaddleOCR.

In an embodiment, a size standardization process in the image enhancement may be implemented by the following steps 11) to 12).

In step 11), an adaptive factor for controlling an adjustment degree of an interpolation kernel is determined based on geometric features of the table in the first image.

The geometric features of the table may include, but are not limited to, features such as a row spacing, a column spacing, and a cell size of the table.

In step 12), a size and shape of the interpolation kernel are adjusted based on the adaptive factor, and interpolation-based scaling is performed on the first image using an adjusted interpolation kernel to obtain a standard-sized image.

In this embodiment, the size standardization of the image is performed based on an interpolation algorithm.

In order to improve the quality of the size standardization of the image, in the process of standardizing the size of the image based on the interpolation algorithm, firstly, primary analysis is performed on the input image (such as, the first image) to roughly recognize a table area and a non-table area in the image. Next, an adaptive factor is calculated based on the geometric features of the table (such as, a row spacing, a column spacing, and a cell size). During an interpolation process, a size and shape of the interpolation kernel are dynamically adjusted using the adaptive factor to ensure that the geometric proportions and relative positions of the table area remain unchanged after scaling.

Here, the adaptive factor is used to control the adjustment degree of the interpolation kernel to achieve an optimal scaling effect.

In embodiments of the present disclosure, the image is scaled to a target resolution by performing size standardization on the image, to obtain a standard-sized image with the target resolution. The target resolution may be set based on actual application requirements. For example, the target resolution may be 800×600 pixels and the like. In an embodiment, when setting the target resolution, the resolution of an original image (such as the first image) on which the size standardization is to be performed and the complexity of the table may be taken into account to avoid distortion of the image due to excessive scaling.

In this embodiment, by determining an adaptive factor based on the geometric features of the table in the image to adjust the interpolation kernel and scaling the image using the adjusted interpolation kernel, it may be ensured that the geometric proportions and the relative positions of the table area remain unchanged after scaling. Thus, the optimal scaling effect is achieved, and the high-quality image data is provided for the subsequent table recognition steps, thereby being conductive to improving the efficiency and accuracy of the subsequent table recognition steps.

In an embodiment, a grayscale conversion process in the image enhancement may be implemented by the following steps 21) to 24).
In step 21), a color-space analysis is performed on the first image or an image obtained through performing the size standardization on the first image, to obtain a color-space analysis result.

The color-space analysis result may include a primary color and a secondary color (such as, a text color, a table color, and a background color) obtained by recognizing, as well as a distribution and importance of these colors in the image.
In step 22), a weight is assigned to each color based on a distribution and importance of this color, characterized by the color-space analysis result, in the first image or the image obtained through performing the size standardization on the first image.
In step 23), based on the weight corresponding to each color in color channels of each pixel in the first image or the image obtained through performing the size standardization on the first image; weighted averaging is performed on the brightnesses of colors involved in the color channels of the pixel, to obtain a weighted average result of the brightnesses of the pixel.

The weighted average result of the brightnesses of each color involved in the color channels of a pixel may be determined as a gray scale of the pixel.
In step 24), the first image or the image obtained through performing the size standardization on the first image is converted into a grayscale image based on the weighted average result of the brightnesses of each pixels.

In this step 24), specifically, grayscale conversion of the image may be achieved by using the weighted average result of the brightnesses of the colors involved in the color channels of a pixel as the gray scale of the pixel, thereby obtaining a corresponding grayscale image.

Specifically, in this embodiment, the grayscale conversion of the image is performed by proposing and using an adaptively-weighting grayscale conversion method.

Conventional grayscale conversion usually uses a fixed-weight assignment method, resulting in loss of color information of the image. To solve the problem, an adaptively-weighting grayscale conversion method is proposed in embodiments of the present disclosure. In the method, firstly, a color space analysis is performed on the image to recognize a primary color and a secondary color (such as, a text color, a table color, and a background color) of the image. Then, a weight is assigned to each color based on the distribution and importance of this color in the image. During the grayscale conversion process, weighted averaging is performed on the brightness of each color in color channels of a pixel using these weights to retain more key information, and then a weighted average is determined as a grayscale value of the pixel, thereby implementing the grayscale conversion of each pixel of the image.

In practice, a color weight matrix may be obtained by training based on a large number of samples to adapt to different types of document images. During the training process, an optimal color weight matrix may be generated by learning a relationship between different colors and image contents.

In this embodiment, by performing the grayscale conversion of the image using the adaptively-weighting grayscale conversion method, more key information of the image may be retained and the loss of color information may be avoided, thereby providing high-quality image data for the subsequent table recognition steps and further improving the accuracy and efficiency of the subsequent table recognition steps.

In an embodiment, a binarization process in the image enhancement may be implemented by the following steps 31) to 34).
In step 31), the grayscale image is divided into multiple local windows.

The grayscale image may be divided into the multiple local windows by, but not limited to, a traversing-based segmentation method (such as left-to-right and top-to-bottom traversing-based segmentation method) according to a certain local window size.

In an embodiment, the local window size may be automatically adjusted based on an image resolution and a table density. Sizes of the local windows obtained by dividing should be sufficiently large to contain useful local information, but not excessively large to avoid introducing excessive noise.
In step 32), a local contrast of pixels within each of the local windows is calculated.

The local contrast of pixels within local windows may be, but not limited to, a local mean or standard deviation of pixel values within the local windows.
In step 33), for each of the local windows, a binarization threshold is determined for each pixel based on the local contrast of the pixels and a preset contrast threshold.

The contrast threshold may be dynamically calculated based on the statistical characteristics of the image. During the calculation process, factors such as an overall contrast, the local contrast distribution of the image, may be taken into account to generate an adaptive contrast threshold.
In this step 33), specifically, the binarization threshold may be determined for each pixel by referring to a comparison result between the local contrast of the pixels and the contrast threshold.
In step 34), the grayscale image is converted into a binary image based on the binarization threshold corresponding to each pixel.

Conventional binarization processing uses a fixed threshold and is easily affected by light and noise. To address this problem, in embodiments of the present disclosure, an optimal threshold is dynamically determined for each pixel based on the local contrasts of the image. Firstly, the image is divided into multiple local windows, and for each window, the local contrast (such as, a local mean and standard deviation) of pixels is calculated. Then, a binarization threshold is determined for each pixel based on the local contrast and the preset contrast threshold, and then the pixels of the image are binarized based on the binarization threshold dynamically determined for each pixel.

The binarization based on the dynamic binarization threshold provided according to embodiments of the present disclosure may effectively adapt to different lighting and noise conditions, thereby improving the accuracy of the image binarization.

In an embodiment, a table contour detection process in the image enhancement may be implemented by the following steps 41) to 43).
In step 41), a low-level feature and a high-level feature of the binary image are extracted using a convolutional neural network. The low-level feature includes a basic image feature of the binary image, and the high-level feature includes table structure information in the binary image.

The low-level feature may include, but are not limited to, a basic image feature related to an edge, a corner point, and the like; and the high-level feature may include, but are not limited to, complex table structure information related to a table line, a cell relationship, a geometric attribute, and the like.
In step 42), feature fusion is performed on extracted low-level feature and high-level feature using an attention mechanism, to obtain a feature fusion result, where the feature fusion is performed to highlight features related to a contour of the table.

Specifically, feature fusion may be performed on the extracted low-level feature and the high-level feature based on attention weights to highlight features related to the contour of the table by the attention weights.
In step 43), a contour information graph of the table in the binary image is generated based on the feature fusion result.

In this step 43), a complete contour information graph of the table may be generated by a fully-connected layer in a convolutional neural network structure.

The table contour detection in this embodiment is a contour detection based on a multi-level feature fusion.

Specifically, the multi-level feature fusion based contour detection of the table in the image may be performed by a CNN architecture of the Convolutional Neural Networks (CNN).

The CNN architecture may include multiple convolutional layers, a pooling layer, and a fully-connected layer, and its specific structure may be optimized based on experiments to achieve the optimal feature extraction and fusion effect for the table.

Specifically, when performing the table contour detection, firstly, the low-level feature and high-level feature of the image are extracted using the convolutional neural network, in which the CNN may gradually extract these features through multiple convolutional layers and the pooling layer; then, the extracted features are fused using the attention mechanism to highlight the features related to the contour of the table; and finally, the complete contour information graph of the table is generated through the fully-connected layer.

The attention weights may be learned automatically through training. During a training process, optimal attention weights may be generated by learning respective relationships between different features and the contour of the table.

In this embodiment, a basis may be provided for a subsequent angle correction by performing a preliminary table contour detection (different from a subsequent accurate table position detection based on the target agent).

In an embodiment, an angle correction process in the image enhancement may be implemented by the following steps 51) to 53).
In step 51), text rows and table rows in the binary image are determined based on the contour information graph.

In an embodiment, the text rows and table rows in the image may be detected based on the contour information graph of the table using a minimum bounding rectangle fitting method.
In step 52), through a regional voting mechanism, a tilt angle of the binary image is determined based on a tilt-angle voting result of each of the text rows and table rows in the binary image.

During a voting process, each text row or table row is given a vote based on its tilt angle, and accordingly, the tilt angle of the binary image may be determined based on the tilt-angle voting result of each of the text rows and table rows.
In step 53), angle correction is performed on the binary image based on the tilt angle of the binary image.

Specifically, in embodiments of the present disclosure, an adaptive angle correction method based on a geometric transformation and regional voting is proposed to perform angle correction of the image. During an angle correction process, firstly, text rows and table rows in the image may be detected using a minimum bounding rectangle fitting method; then, the tilt angle of the image is determined through the regional voting mechanism, where in the voting process, each text row or table row is given a vote based on its tilt angle; and finally, the overall tilt angle of the image is determined based on the voting result, and the angle correction may be performed on the image based on the overall tilt angle of the image using an affine transformation method.

In an embodiment, for complex documents, a recursive strategy may be further introduced to detect and correct the angle of the image block by block.

In practice, sizes of voting areas (such as, text rows, table rows, or voting areas divided based on other strategies) may be automatically adjusted based on table size and density. The sizes of the voting areas should be sufficiently large to encompass useful voting information, but not excessively large to avoid introducing excessive noise.

Affine transformation parameters, on which the affine transformation is based, may be automatically adjusted by an optimization function used for angle correction. During an optimization/correction process, factors such as an alignment degree of the text lines, a distortion degree of the image may be taken into account to achieve a correction effect of minimizing a tilt degree of the text/table.

In this embodiment, by performing image angle correction using a regional voting mechanism, factors such as tilting and bending of the image affecting the table recognition may be effectively eliminated, thereby supporting subsequent efficient and accurate table recognition.

In an embodiment, a denoising and sharpening process in the image enhancement may be implemented by the following steps 61) to 62).
In step 61), a denoising parameter is determined based on a noise level of an input image, and a sharpening parameter is determined based on local features of the input image.

The input image is an image obtained through processing of the first image, such as an image obtained through size standardization, grayscale processing, binarization, and angle correction.

The local features may include local features of edge areas and local features of non-edge areas of the input image.

The denoising parameter may include, but is not limited to, denoising strength, and the sharpening parameter may include, but is not limited to, sharpening strength.
In step 62), the input image is denoised based on the denoising parameter and is sharpened based on the sharpening parameter.

Specifically, in this embodiment, the image is denoised based on a deep learning adaptive denoising network. The adaptive denoising network uses deep learning technology to learn noise patterns in the image and automatically adjust the denoising parameter such as the denoising strength. During a training process of the denoising network, the network learns denoising strategies under different noise types and degrees to generate a denoising model network with strong adaptability. During a denoising process, the network automatically adjusts the denoising parameter such as denoising strength based on the noise level of the input image to ensure that important image details are retained while removing noise.

The network structure of the adaptive denoising network may include multiple convolutional layers, residual connection, and an activation function. A specific structure may be optimized based on a type and degree of noise to achieve effective removal of noise and maintain the clarity of image edges, thereby ensuring the highest denoising performance.

The denoising strength is used to control a denoising degree of the network to avoid image distortion caused by excessive denoising. In practice, the denoising strength may also be automatically adjusted based on the complexity of the image content. The complexity of the image content may be evaluated by analyzing features such as a noise level and texture complexity of the image.

Conventional Laplacian sharpening may over-enhance the noise, resulting in degradation of image quality. To overcome this problem, in this embodiment, the sharpening parameter such as the sharpening strength is automatically adjusted based on local features of the image, such as edge strength and texture density, to achieve an adaptive Laplacian sharpening and avoid the degradation of the image quality.

In the adaptive Laplacian sharpening, firstly, edge areas and non-edge areas of the image are detected. For the edge areas, a stronger sharpening parameter (such as, stronger sharpening strength) is used to highlight edge details; and for non-edge areas, a weaker sharpening parameter (such as, weaker sharpening strength) is used to avoid noise enhancement.

Here, the sharpening parameter such as the sharpening strength may be calculated dynamically based on the local features of the image. During a calculation process, local features such as edge strength and texture density may be taken into account, but not limited thereto, to generate an adaptive sharpening parameter such as sharpening strength.

In addition, a size of the Laplacian operator may be automatically adjusted based on a resolution and table density of the image to achieve a more natural sharpening effect. The Laplacian operator itself is not a sharpening parameter, but it may be used in an image sharpening process.

The size of the Laplacian operator may be automatically adjusted based on the resolution and table density of the image. The size of the operator should be sufficiently large to capture useful edge information, but not excessively large to avoid introducing excessive noise.

In embodiments of the present disclosure, a series of detailed image enhancement technologies as described above may be used to provide a high-quality image basis for subsequent fast and highly-accurate table recognition steps. Here, the size standardization ensures consistency of the image, the grayscale conversion and the binarization simplify the image data and retain key information, the contour detection extracts a contour of the table, the angle correction corrects factors such as an image tilting and table bending which are not conducive to the table recognition, and denoising and sharpening improve clarity of the image. A combined application of these technologies significantly improves a final accuracy and robustness of the table recognition.

In an embodiment, a process for constructing the target agent is further provided.

The process for constructing the target agent may be implemented by the following steps 71) to 73).
In step 71), through transfer learning, pre-trained model weights are provided respectively for a first deep learning model in the first branch and a second deep learning model in the second branch; a pre-trained model weight provided for the first deep learning model being used to extract structural features of the table, and a pre-trained model weight provided for the second deep learning model being used to extract text semantic features of the table.

The first deep learning model may be, but not limited to, a deep learning model such as TabNet.

The second deep learning model may be, but not limited to, a structured learning model such as StructEqTable.
In step 72), optimization is performed on an obtained first deep learning model and an obtained second deep learning model obtained through the transfer learning using small sample learning.
In step 73), data augmentation is performed on samples in the small sample learning, and optimization is performed on the obtained first deep learning model and the obtained second deep learning model obtained through the transfer learning using the augmented samples.

During an optimization process, the first deep learning model and the second deep learning model may be optimized independently in their respective branches, and may share table information and features.

The above implementation is further described in detail below.

In this embodiment, a dual-branch model optimization method is used with technologies such as transfer learning, small-sample training and data augmentation, so that a model may, for a table recognition task, be efficiently trained based on a small amount of labeled data, thereby significantly improving the recognition capability and adaptability of the model. The core idea of the method is to simultaneously optimize the generalization ability of the model on different table layouts and styles through a parallel processing of a dual-branch structure, thereby enhancing its adaptability to a new task and new data.

In an embodiment, an advanced deep-learning table detection model (that is, a target agent) may be constructed by using, but not limited to, a dual-branch structure based on TabNet and StructEqTable, and a recognition ability of a model in complex scenarios is improved by small-sample optimization, and a generalization ability and recognition accuracy of the model are improved based on limited labeled data by methods such as transfer learning and data augmentation.

The core concept of the dual-branch structure is to divide the processing process of the model into two parallel branches, each of which is optimized for different data processing tasks to better cope with the complexity of the table data and small-sample learning. Specifically, the two branches perform the following operations.

A first branch is a branch for learning structural features of the table.

The first branch focuses on learning structural features of table data, especially table lines, cell relationships, and geometric properties of the table. The first branch may extract key geometric information and structural features from a table by using a deep learning model such as TabNet, to recognize a basic layout and data arrangement of the table.

In the first branch, the model focuses on deep learning of the structural features of the table to establish understanding of a spatial structure and data distribution of the table, ensuring accurate detection and labeling of a table area. The first branch is configured to extract the structural features of the table in the image after the construction of the model (the target agent), to perform table detection based on the extracted structural features of the table.

A second branch is a branch for learning semantic information.

The second branch focuses on capturing text information features in the table, such as text content, data values, and table-header information. The second branch may learn the semantic features of the table data and understand a relationship between the texts by a structured learning model such as StructEqTable.

The second branch may learn the texts in the table through a deep learning network and extract important text information in the table based on natural language processing (NLP) technology. As such, the model may accurately recognize the meaning of the texts and a structure of the table through the two branches even when the structure of the table is complex or a text position changes.

The dual-branch structure proposed in the present disclosure provides a powerful support for model optimization and small-sample training. Under this framework, the model may be efficiently trained on limited labeled data, thereby improving its performance in new scenarios and tasks. The specific optimization process includes the following three key steps: transfer learning, small-sample training and data augmentation.

Through the transfer learning, the knowledge obtained by a pre-trained model from a large-scale dataset may be transferred to a small-sample task, thereby reducing time and cost for training the target agent from scratch. The transfer learning may provide pre-trained model weights for the two branches in the dual-branch structure in the present disclosure, thereby helping the model to quickly adapt to new tasks.

On the basis of the transfer learning, the model is further optimized through small-sample learning, so that the model may maintain high recognition accuracy with limited data samples. Through the small-sample learning, the model may extract generic features from limited samples and adapt thereto, thereby to improve its ability to recognize different table formats.

The dual-branch model may share information and features while each branch is optimized independently to facilitate efficient training of the model based on a small amount of samples. With this strategy, the two branches may implement information fusing while ensuring individualized learning, thereby further improving the performance of the finally obtained table detection model (the target agent).

In practice and for example, a certain number of, for example 5000, PDF files may be randomly selected from a data source of portable document format files as sample data. A part of the selected PDF files serve as training samples and the remaining part serve as validation samples. For example, 4,000 PDF files serve as training samples and the remaining 1,000 PDF files serve as validation samples. As the table detection model performs target detection on a page image, the following operations are required. Firstly, a page in the PDF sample data is required to be converted to an image, and then image enhancements such as size standardization, grayscale conversion, binarization, contour detection, angle correction as well as denoising and sharpening are performed on the page image.

On this basis, an open-source deep learning image labeling tool such as labelme may be further used to label table areas of image data obtained through the enhancements to prepare small samples, and then the model is optimized based on the small samples. The labeling type may include the following label: table.

In this embodiment, due to the lack of labeled data, augmented samples are further constructed by performing different augmentation processing (such as, table rotation, noise addition, random cropping) on original small-sample data, so that the model may expand the feature space for its learning by simulating different table formats and layouts. The augmented image data provides more training samples for the model, thereby improving generalization ability of the model.

Each branch in the dual-branch structure may independently apply a data augmentation strategy to ensure that each branch may effectively learn under different data changes and obtain diverse feature information.

After that, dual-branch optimization may be performed based on the constructed samples to improve the table recognition accuracy of the model.

The first branch (a structural-feature branch of the table), which focuses on a spatial structure of the table, may, but not limited to, use TabNet model and adopt a feature selection mechanism and an attention mechanism to optimize its extraction ability of structural features of the table. During an optimization process of this branch, the model may understand a geometric layout of the table through a multi-level decision-making process to automatically capture an arrangement and key elements of the table.

The second branch (semantic-feature branch) may, but not limited to, adopt a StructEqTable model to strengthen its learning of text information, especially texts and data in the table. This branch may improve the model's understanding of the relationships between data, table headers, and cells by understanding contexts of the table, to ensure that structural information and text information of the table may be accurately recognized even when the table contents are complex.

With the dual-branch structure, the model may optimize the feature learning and extraction capabilities of the table in terms of geometric structural features and semantic features at the same time, thereby obtaining more comprehensive and detailed table understanding results.

After optimization of the dual-branch model, optionally, an optimized model may be further validated based on the validation samples. Experimental results show that when using only a small amount of labeled data, a dual-branch model after being optimized improves the table recognition accuracy by about 12%-18% compared to traditional methods, and adaptability of the model is significantly enhanced especially when dealing with tables in different formats or diverse layouts.

In this embodiment, a table detection model (the target agent) is trained through a dual-branch structure and a small-sample method, so that the model can efficiently learn geometric structures and semantic information features of a table based on a small amount of data samples, and the generalization ability of the model in diverse table formats and layouts is improved.

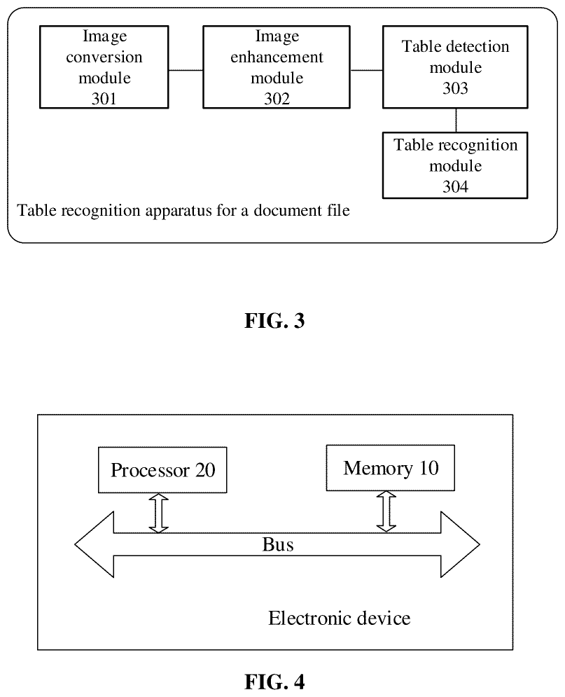

Corresponding to the method described above, a table recognition apparatus for a document file is further provided according to an embodiment of the present disclosure. Referring to a schematic structural diagram of FIG. 3, the apparatus includes an image conversion module 301, an image enhancement module 302, a table detection module 303 and a table recognition module 304.

The image conversion module 301 is configured to convert a page of a to-be-processed document file into a first image.

The image enhancement module 302 is configured to perform image enhancement on the first image to obtain a second image. The image enhancement is performed to at least implement angle correction of the first image.

The table detection module 303 is configured to perform table detection on the second image using a target agent to obtain table-area position information of a table in the second image. The target agent is a table detection model constructed based on deep learning-based dual-branch model optimization, a first branch of the target agent being configured to learn and extract structural features of the table, and a second branch of the target agent being configured to learn and extract text semantic features of the table.

The table recognition module 304 is configured to recognize table data in a table area indicated by the table-area position information and converting recognized table data into data in a structured format for outputting.

In an embodiment, the image enhancement module 302 is further configured to perform at least one of size standardization, grayscale conversion, binarization, table contour detection, angle correction, as well as denoising and sharpening process on the first image.

In an embodiment, the image enhancement module 302, when performing the size standardization, is further configured to: determine an adaptive factor for controlling an adjustment degree of an interpolation kernel based on geometric features of the table in the first image; and adjust a size and shape of the interpolation kernel based on the adaptive factor, and perform interpolation-based scaling on the first image using an adjusted interpolation kernel to obtain a standard-sized image.

In an embodiment, the image enhancement module 302, when performing the grayscale conversion, is further configured to: perform color-space analysis on the first image or an image obtained through performing the size standardization on the first image to obtain a color-space analysis result; assign a weight to each color based on a distribution and importance of this color, characterized by the color-space analysis result, in the first image or the image obtained through performing the size standardization on the first image; based on the weight corresponding to each color in color channels of each pixel in the first image or the image obtained through performing the size standardization on the first image, perform weighted averaging on brightnesses of colors involved in the color channels of the pixel, to obtain a weighted average result of the brightnesses of the pixel; and convert the first image or the image obtained through performing the size standardization on the first image into a grayscale image based on the weighted average result of the brightnesses of each pixel.

The image enhancement module 302, when performing the binarization, is further configured to: divide the grayscale image into multiple local windows; calculate a local contrast of pixels within each of the local windows; for each of the local windows, determinea binarization threshold for each pixel based on the local contrast of the pixels and a preset contrast threshold; and convert the grayscale image into a binary image based on the binarization threshold corresponding to each pixel.

In an embodiment, the image enhancement module 302, when performing the table contour detection, is further configured to: extract a low-level feature and a high-level feature of the binary image using a convolutional neural network, where the low-level feature comprises a basic image feature of the binary image, the high-level feature comprises table structure information in the binary image, and the binary image is a result of binarizing the first image; perform feature fusion on extracted low-level feature and high-level feature using an attention mechanism to obtain a feature fusion result, where the feature fusion is performed to highlight features related to a contour of the table; and generate a contour information graph of the table in the binary image based on the feature fusion result.

The image enhancement module 302, when performing the angle correction, is further configured to: determine text rows and table rows in the binary image based on the contour information graph; determine a tilt angle of the binary image based on a tilt-angle voting result of each of the text rows and table rows in the binary image through a regional voting mechanism; and perform angle correction on the binary image based on the tilt angle of the binary image.

In an embodiment, the image enhancement module 302, when performing the denoising and sharpening process, is further configured to: determine a denoising parameter based on a noise level of an input image, and determine a sharpening parameter based on local features of the input image, where the input image is an image obtained through processing of the first image; and denoise the input image based on the denoising parameter and sharpen the input image based on the sharpening parameter.

In an embodiment, the apparatus further includes a model construction module, and the model construction module is configured to: provide, through transfer learning, pre-trained model weights respectively for a first deep learning model in the first branch and a second deep learning model in the second branch, where a pre-trained model weight provided for the first deep learning model is used to extract structural features of the table, and a pre-trained model weight provided for the second deep learning model is used to extract text semantic features of the table; optimize an obtained first deep learning model and an obtained second deep learning model obtained through the transfer learning using small sample learning; perform data augmentation on samples in the small sample learning, and optimize the obtained first deep learning model and the obtained second deep learning model obtained through the transfer learning using the augmented samples, where during the optimizing, the first deep learning model and the second deep learning model are optimized independently in respective branches, and share table information and features.

The table recognition apparatus for a document file disclosed in the embodiments of the present disclosure correspond to the table recognition method for a document file document disclosed in the above method embodiments, and therefore are described in a relatively simply manner. Relevant similarities may refer to the description of the method embodiments, which are not described in detail here.

An electronic device is further provided in the embodiment of the present disclosure. The compositional structure of the electronic device is illustrated in FIG. 4, and the electronic device at least includes a memory 10 and a processor 20. The memory 10 stores a computer program. The processor 20 is configured to perform the table recognition method for a document file provided according to any one of the above method embodiments by invoking and executing the computer program in the memory.

The processor 20 may be a central processing unit (CPU), an application-specific integrated circuit (ASIC), a digital signal processor (DSP), a field programmable gate array (FPGA), a neural-network processing unit (NPU), a deep learning processing unit (DPU) or another programmable logical device.

In addition, the electronic device may include components such as a communication interface, a communication bus. The memory, the processor and the communication interface communicate with each other via the communication bus.

The communication interface is configured for communication between the electronic device and other devices. The communication bus may be a peripheral component interconnect (PCI) bus, an extended industry standard architecture (EISA) bus and the like. The communication bus may include an address bus, a data bus, a control bus, and the like.

In addition, a computer readable medium storing a computer program is further provided according to the present disclosure. The computer program includes program code for performing the table recognition method for a document file provided according to any one of the above method embodiments. The computer program performs, when being executed by a processor, the table recognition method for a document file provided according to any one of the above method embodiments.

In the context of the present disclosure, the computer readable medium (a machine readable medium) may be a tangible medium including or storing a program that is used by or used in combination with an instruction execution system, an apparatus or a device. The machine readable medium may be a machine readable signal medium or a machine readable storage medium. The machine readable medium may include, but is not limited to, system, an apparatus, or a device in an electronic, magnetic, optical, electromagnetic, infrared, or semi-conductive form, or any suitable combination thereof. More specific examples of the machine readable storage medium may include, one or more wire-based electrical connections, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device or any suitable combination thereof.

It should be noted that all the embodiments in this specification are described in a progressive way, and each embodiment focuses on the differences from other embodiments. The same and similar parts among the embodiments can be referred to each other.

For convenience of description, the system and apparatus are described by dividing the system and apparatus into modules or units by functions. Functions of the various units may be achieved in one or more software and/or hardware when implementing the present disclosure.

As can be seen from the above description of the embodiments, those skilled in the art can clearly understand that the present disclosure can be implemented by software plus a necessary general hardware platform. Based on such understanding, the technical solutions of the present disclosure or the part of the technical solutions of the present disclosure contributed to the conventional technology may be embodied in a form of a software product. The computer software product may be stored in a storage medium, such as an ROM/RAM, a magnetic disk and an optical disk, which includes several instructions to cause a computer device (may be a personal computer, a server, network device and the like) to execute the method according to the embodiments or some parts of the embodiments of the present disclosure.

Finally, it should further be noted that the relationship terminologies such as “first”, “second”, “third”, “target” and the like are only used herein to distinguish one entity or operation from another, rather than to necessitate or imply that the actual relationship or order exists between the entities or operations. Furthermore, the term “comprise”, “include” or any other variation thereof is intended to cover a non-exclusive inclusion, so that a process, a method, an article, or a device including a set of elements includes not only those elements, but also other elements not expressly listed or elements inherent in such a process, method, article, or device. Unless expressively limited, the statement “including a . . . ” does not exclude the case that other similar elements may exist in the process, method, article or device including the elements.

Hereinabove described are only preferred embodiments of the present disclosure. It should be noted that improvements and modifications can be made by those of ordinary skills in the art, without departing from the principles of the present disclosure. Such improvements and modifications fall within the protection scope of the present disclosure.

1. A table recognition method for a document file, comprising:
converting a page of a to-be-processed document file into a first image;
performing image enhancement on the first image to obtain a second image, wherein the image enhancement is performed to at least implement angle correction of the first image;
performing table detection on the second image using a target agent to obtain table-area position information of a table in the second image, wherein the target agent is a table detection model constructed based on deep learning-based dual-branch model optimization, a first branch of the target agent being configured to learn and extract structural features of the table, and a second branch of the target agent being configured to learn and extract text semantic features of the table; and
recognizing table data in a table area indicated by the table-area position information and converting recognized table data into data in a structured format for outputting.

2. The table recognition method for a document file according to claim 1, wherein the performing image enhancement on the first image comprises:
performing at least one of size standardization, grayscale conversion, binarization, table contour detection, angle correction, as well as denoising and sharpening processing on the first image.

3. The table recognition method for a document file according to claim 2, wherein the size standardization is performed by:
determining an adaptive factor for controlling an adjustment degree of an interpolation kernel based on geometric features of the table in the first image; and
adjusting a size and shape of the interpolation kernel based on the adaptive factor, and performing interpolation-based scaling on the first image using an adjusted interpolation kernel, to obtain a standard-sized image.

4. The table recognition method for a document file according to claim 2, wherein the grayscale conversion is performed by:
performing color-space analysis on the first image or an image obtained through performing the size standardization on the first image to obtain a color-space analysis result;
assigning a weight to each color based on a distribution and importance of this color, characterized by the color-space analysis result, in the first image or the image obtained through performing the size standardization on the first image;
based on the weight corresponding to each color in color channels of each pixel in the first image or the image obtained through performing the size standardization on the first image, performing weighted averaging on brightnesses of colors involved in the color channels of the pixel, to obtain a weighted average result of the brightnesses of the pixel; and
converting the first image or the image obtained through performing the size standardization on the first image into a grayscale image based on the weighted average result of the brightnesses of each pixel; and
wherein the binarization is performed by:
dividing the grayscale image into a plurality of local windows;
calculating a local contrast of pixels within each of the local windows;
for each of the local windows, determining a binarization threshold for each pixel based on the local contrast of the pixels and a preset contrast threshold; and
converting the grayscale image into a binary image based on the binarization threshold corresponding to each pixel.

5. The table recognition method for a document file according to claim 2, wherein the table contour detection is performed by:
extracting a low-level feature and a high-level feature of the binary image using a convolutional neural network, wherein the low-level feature comprises a basic image feature of the binary image, the high-level feature comprises table structure information in the binary image, and the binary image is a result of binarizing the first image;
performing feature fusion on extracted low-level feature and high-level feature using an attention mechanism to obtain a feature fusion result, wherein the feature fusion is performed to highlight features related to a contour of the table;
generating a contour information graph of the table in the binary image based on the feature fusion result; and
wherein the angle correction is performed by:
determining text rows and table rows in the binary image based on the contour information graph;
determining a tilt angle of the binary image based on a tilt-angle voting result of each of the text rows and table rows in the binary image through a regional voting mechanism; and
performing angle correction on the binary image based on the tilt angle of the binary image.

6. The table recognition method for a document file according to claim 2, wherein the denoising and sharpening processing is performed by:
determining a denoising parameter based on a noise level of an input image, and determining a sharpening parameter based on local features of the input image, wherein the input image is an image obtained through processing of the first image;
denoising the input image based on the denoising parameter and sharpening the input image based on the sharpening parameter.

7. The table recognition method for a document file according to claim 1, wherein a process for constructing the target agent comprises at least one of the following:
providing, through transfer learning, pre-trained model weights respectively for a first deep learning model in the first branch and a second deep learning model in the second branch, wherein a pre-trained model weight provided for the first deep learning model is used to extract structural features of the table, and a pre-trained model weight provided for the second deep learning model is used to extract text semantic features of the table;
optimizing an obtained first deep learning model and an obtained second deep learning model obtained through the transfer learning using small sample learning; and
performing data augmentation on samples in the small sample learning, and optimizing the obtained first deep learning model and the obtained second deep learning model obtained through the transfer learning using the augmented samples;
wherein during the optimizing, the first deep learning model and the second deep learning model are optimized independently in respective branches, and share table information and features.

8. An electronic device, comprising:
a memory, configured to store a computer program;
a processor, configured to perform, by invoking and executing the computer program in the memory, operations comprising:
converting a page of a to-be-processed document file into a first image;
performing image enhancement on the first image to obtain a second image, wherein the image enhancement is performed to at least implement angle correction of the first image;
performing table detection on the second image using a target agent to obtain table-area position information of a table in the second image, wherein the target agent is a table detection model constructed based on deep learning-based dual-branch model optimization, a first branch of the target agent being configured to learn and extract structural features of the table, and a second branch of the target agent being configured to learn and extract text semantic features of the table; and
recognizing table data in a table area indicated by the table-area position information and converting recognized table data into data in a structured format for outputting.

9. The electronic device according to claim 8, wherein the performing image enhancement on the first image comprises:
performing at least one of size standardization, grayscale conversion, binarization, table contour detection, angle correction, as well as denoising and sharpening processing on the first image.

10. The electronic device according to claim 9, wherein the size standardization is performed by:
determining an adaptive factor for controlling an adjustment degree of an interpolation kernel based on geometric features of the table in the first image; and
adjusting a size and shape of the interpolation kernel based on the adaptive factor, and performing interpolation-based scaling on the first image using an adjusted interpolation kernel, to obtain a standard-sized image.

11. The electronic device according to claim 9, wherein the grayscale conversion is performed by:
performing color-space analysis on the first image or an image obtained through performing the size standardization on the first image to obtain a color-space analysis result;
assigning a weight to each color based on a distribution and importance of this color, characterized by the color-space analysis result, in the first image or the image obtained through performing the size standardization on the first image;
based on the weight corresponding to each color in color channels of each pixel in the first image or the image obtained through performing the size standardization on the first image, performing weighted averaging on brightnesses of colors involved in the color channels of the pixel, to obtain a weighted average result of the brightnesses of the pixel; and
converting the first image or the image obtained through performing the size standardization on the first image into a grayscale image based on the weighted average result of the brightnesses of each pixel; and
wherein the binarization is performed by:
dividing the grayscale image into a plurality of local windows;
calculating a local contrast of pixels within each of the local windows;
for each of the local windows, determining a binarization threshold for each pixel based on the local contrast of the pixels and a preset contrast threshold; and
converting the grayscale image into a binary image based on the binarization threshold corresponding to each pixel.

12. The electronic device according to claim 9, wherein the table contour detection is performed by:
extracting a low-level feature and a high-level feature of the binary image using a convolutional neural network, wherein the low-level feature comprises a basic image feature of the binary image, the high-level feature comprises table structure information in the binary image, and the binary image is a result of binarizing the first image;
performing feature fusion on extracted low-level feature and high-level feature using an attention mechanism to obtain a feature fusion result, wherein the feature fusion is performed to highlight features related to a contour of the table;
generating a contour information graph of the table in the binary image based on the feature fusion result; and
wherein the angle correction is performed by:
determining text rows and table rows in the binary image based on the contour information graph;
determining a tilt angle of the binary image based on a tilt-angle voting result of each of the text rows and table rows in the binary image through a regional voting mechanism; and
performing angle correction on the binary image based on the tilt angle of the binary image.

13. The electronic device according to claim 9, wherein the denoising and sharpening processing is performed by:
determining a denoising parameter based on a noise level of an input image, and determining a sharpening parameter based on local features of the input image, wherein the input image is an image obtained through processing of the first image;
denoising the input image based on the denoising parameter and sharpening the input image based on the sharpening parameter.

14. The electronic device according to claim 8, wherein a process for constructing the target agent comprises at least one of the following:
providing, through transfer learning, pre-trained model weights respectively for a first deep learning model in the first branch and a second deep learning model in the second branch, wherein a pre-trained model weight provided for the first deep learning model is used to extract structural features of the table, and a pre-trained model weight provided for the second deep learning model is used to extract text semantic features of the table;
optimizing an obtained first deep learning model and an obtained second deep learning model obtained through the transfer learning using small sample learning; and
performing data augmentation on samples in the small sample learning, and optimizing the obtained first deep learning model and the obtained second deep learning model obtained through the transfer learning using the augmented samples;
wherein during the optimizing, the first deep learning model and the second deep learning model are optimized independently in respective branches, and share table information and features.

15. A non-transitory computer readable medium storing a computer program, wherein the computer program performs, when being executed by a processor, operations comprising:
converting a page of a to-be-processed document file into a first image;
performing image enhancement on the first image to obtain a second image, wherein the image enhancement is performed to at least implement angle correction of the first image;
performing table detection on the second image using a target agent to obtain table-area position information of a table in the second image, wherein the target agent is a table detection model constructed based on deep learning-based dual-branch model optimization, a first branch of the target agent being configured to learn and extract structural features of the table, and a second branch of the target agent being configured to learn and extract text semantic features of the table; and
recognizing table data in a table area indicated by the table-area position information and converting recognized table data into data in a structured format for outputting.

16. The non-transitory computer readable medium according to claim 15, wherein the performing image enhancement on the first image comprises:
performing at least one of size standardization, grayscale conversion, binarization, table contour detection, angle correction, as well as denoising and sharpening processing on the first image.

17. The non-transitory computer readable medium according to claim 16, wherein the size standardization is performed by:
determining an adaptive factor for controlling an adjustment degree of an interpolation kernel based on geometric features of the table in the first image; and
adjusting a size and shape of the interpolation kernel based on the adaptive factor, and performing interpolation-based scaling on the first image using an adjusted interpolation kernel, to obtain a standard-sized image.

18. The non-transitory computer readable medium according to claim 16, wherein the grayscale conversion is performed by:
performing color-space analysis on the first image or an image obtained through performing the size standardization on the first image to obtain a color-space analysis result;
assigning a weight to each color based on a distribution and importance of this color, characterized by the color-space analysis result, in the first image or the image obtained through performing the size standardization on the first image;
based on the weight corresponding to each color in color channels of each pixel in the first image or the image obtained through performing the size standardization on the first image, performing weighted averaging on brightnesses of colors involved in the color channels of the pixel, to obtain a weighted average result of the brightnesses of the pixel; and
converting the first image or the image obtained through performing the size standardization on the first image into a grayscale image based on the weighted average result of the brightnesses of each pixel; and
wherein the binarization is performed by:
dividing the grayscale image into a plurality of local windows;
calculating a local contrast of pixels within each of the local windows;
for each of the local windows, determining a binarization threshold for each pixel based on the local contrast of the pixels and a preset contrast threshold; and
converting the grayscale image into a binary image based on the binarization threshold corresponding to each pixel.

19. The non-transitory computer readable medium according to claim 16, wherein the table contour detection is performed by:
extracting a low-level feature and a high-level feature of the binary image using a convolutional neural network, wherein the low-level feature comprises a basic image feature of the binary image, the high-level feature comprises table structure information in the binary image, and the binary image is a result of binarizing the first image;
performing feature fusion on extracted low-level feature and high-level feature using an attention mechanism to obtain a feature fusion result, wherein the feature fusion is performed to highlight features related to a contour of the table;
generating a contour information graph of the table in the binary image based on the feature fusion result; and
wherein the angle correction is performed by:
determining text rows and table rows in the binary image based on the contour information graph;
determining a tilt angle of the binary image based on a tilt-angle voting result of each of the text rows and table rows in the binary image through a regional voting mechanism; and
performing angle correction on the binary image based on the tilt angle of the binary image.

20. The non-transitory computer readable medium according to claim 16, wherein the denoising and sharpening processing is performed by:
determining a denoising parameter based on a noise level of an input image, and determining a sharpening parameter based on local features of the input image, wherein the input image is an image obtained through processing of the first image;
denoising the input image based on the denoising parameter and sharpening the input image based on the sharpening parameter.
